(19) United States
(12) Patent Application Publication
(10) Pub. No.: US 2011/0047282 A1
(43) Pub. Date: Feb. 24, 2011

(54) SYSTEMS, METHODS, AND COMPUTER READABLE MEDIA FOR SELECTING AN OPTIMAL MEDIA-ADAPTATION RESOURCE FOR LATENCY-SENSITIVE APPLICATIONS

(76) Inventors: Robert E. Denman, Plano, TX (US); Natalia Schenck, Dallas, TX (US)

Correspondence Address: JENKINS, WILSON, TAYLOR & HUNT, P. A., 3100 Tower Blvd., Suite 1200, DURHAM, NC, 27707, US

(21) Appl. No.: 12/860,605

(22) Filed: Aug. 20, 2010

Related U.S. Application Data
(60) Provisional application No. 61/236,055, filed on Aug. 21, 2009.

(51) Int. Cl. G06F 15/16

(52) U.S. Cl. 709/231

(57) ABSTRACT

Systems, methods, and computer readable media for selecting an optimal media-adaptation resource for latency-sensitive applications are disclosed. According to one aspect, the subject matter described herein includes a method for selecting an optimal media-adaptation resource for latency-sensitive applications. The method includes determining a need for a media-adaptation resource for a media stream between nodes in a telecommunications network, and, at a selection entity for selecting media-adaptation resources, selecting, from a plurality of media-adaptation resources, a media-adaptation resource for the media stream based on an Internet protocol (IP) topological proximity of the resource to at least one of the nodes.

### TECHNICAL FIELD

The subject matter described herein relates to methods and systems for allocating resources within a telecommunications network. More particularly, the subject matter described herein relates to systems, methods, and computer readable media for selecting an optimal media-adaptation resource for latency-sensitive applications.

### BACKGROUND

The standards and protocols of Internet protocol (IP) multimedia subsystem (IMS) networks and next generation networks (NGNs) are defined in a number of documents and technical specifications, such as in 3^{rd} generation partnership project (3GPP) technical specifications TS 21.905, TS 23.002, TS 23.218, TS 23.228, TS 23.401, and TS 23.894, the disclosures of which are incorporated by reference herein in their entireties.

A telecommunications network may be conceptually divided into a core, access, and backhaul networks. The core network is the backbone of the network, and usually contains high-speed and/or high-capacity links for bearer traffic as well as network entities that manage information about subscribers to network services and visitors to the network and that also provide services to subscribers or visitors to the network. The access, or edge, network includes the access points to the network and may include small sub-networks at the edge of the hierarchical network; the backhaul network connects these access points or sub-networks together. For example, a second generation cellular or mobile network includes at least one base transceiver station (BTS), i.e., the cell phone tower and transmitter/receiver, controlled by a base station controller (BSC). The BSC and multiple BTSs are connected together via a backhaul network. Backhaul networks are used to connect wireless base stations to a base station controller or to connect digital subscriber line (DSL) access multiplexers (DSLAMs) to an asynchronous transfer mode (ATM) or Ethernet aggregation node.

A telecommunications network may also be conceptually divided into several planes: a signaling plane, a bearer plane, and a management plane. The signaling plane carries signaling messages, which are messages that are sent between the nodes of the network as part of the process of setting up or taking down either voice calls or data connections and sessions. The bearer plane is so-called because it bears the bulk of the communications traffic across the network. For example, signaling plane messages are used to establish a telephone call between a mobile phone and a wireline telephone, but the call data, e.g., the digitally encoded voice data, is transmitted via the bearer plane. The bearer plane may also be referred to as the user plane (since the user's data, e.g., their voice in a voice call, is what is being transmitted) or, more recently, the media plane. The management plane carries management messages, which are messages that are used to give notification of the health or performance of the network, including traffic, node, and link conditions, to send reports or notifications of particular events within the network, and to send instructions or configuration commands not related to call setup or takedown to nodes within the network. Depending on the specific type of telecommunication network, the signaling, bearer, and management planes may all share common physical resources, such as routing nodes and the physical connections or links between them, or one or more planes may be physically separate from the others, using a separate set of hardware, nodes, or links.

One challenge faced by telecommunications networks is that media streams, whether they be audio streams, such as voice data for a telephone call or digitally encoded music, video streams, such as digitally encoded video, or other type of media, may be in a variety of formats. For example, there are a variety of encoder/decoder (codec) standards for digitally encoded voice data. These codecs may encode and optionally compress voice data using different methods or techniques. Examples of popular speech codecs include ITU-T G.711, ITU-T G.726 (ADPCM), and 3GPP GSM adaptive multi-rate (AMR). Audio codecs include MPEG-1 Audio Layer 3 (MP3) and Advanced Audio Coding (AAC). Video codecs include MPEG-4 Part 2, H.264, and others. In addition, image or video data may have a particular resolution, number of colors, and other characteristics. Thus, a media stream may require various types of conversions, such as transcoding (which changes the way that media data is encoded), transrating (which changes the sampling rate of audio or the frame rate of video, for example), trans-sizing (which changes, the screen size of a video), which are collectively referred to as “media adaptation.”

For example, in order for communication to occur between two devices that do not support any codecs in common, such as may be the case when one device is a mobile telephone or cellular telephone (hereinafter referred to generically as a “cell phone”) and the other device is fixed-line telephone or even another cell phone, the telecommunications network must provide some form of transcoding to convert a media stream that has been encoded using one codec standard into a media stream that has been encoded using another codec standard.

This transcoding operation, which is a type of media adaptation, may be performed by what is generically referred to as a media-adaptation resource. A media adaptation resource is typically hardware, such as a computer or processor with memory for storing data and execution instructions, etc. A media adaptation resource may also contain software and/or firmware. For example, a media-adaptation resource may be a suitably programmed general purpose processor or may include one or more digital signal processors (DSPs). Telecommunications networks typically have many media-adaptation resources, which may be logically organized into pools. For example, a telecommunications network may include a telecommunications frame having shelves with a number of cards, or blades, each card containing one or more media-adaptation resource modules.

During the procedure for setting up a voice call or other media stream between two or more nodes in a network or across networks, the signaling nodes attempt to negotiate a format for the media stream. If there is no codec or media stream format that is supported by both the source and destination nodes, a signaling node may recognize this and request a media-adaptation resource. If a media-adaptation resource is available, the media stream may be routed through the media-adaptation resource, which converts the media stream between a format used by the source and a format supported by the destination, and vice versa, if necessary.

However, a network may include multiple media-adaptation resources or multiple pools of media-adaptation resources from which to choose. One disadvantage of the IMS and NON network standards is that they do not address optimal selection of a media-adaptation resource so as to minimize backhaul delay from communicative nodes (e.g., nodes that communicate among each other) to the media adaptation resource for latency-sensitive applications such as voice telephony. Having the ability to select an optimal media-adaptation resource for latency sensitive applications could provide a higher quality of experience (QoE) to the customer, and may benefit the operator by minimizing or reducing the backhaul network cost outlay, such as capital expenditures and operating expenditures.

Thus, there exists a need for systems, methods, and computer readable media for selecting an optimal media-adaptation resource for latency-sensitive applications.

### SUMMARY

According to one aspect, the subject matter described herein includes a method for selecting an optimal media-adaptation resource for latency-sensitive applications. The method includes determining a need for a media-adaptation resource for a media stream between nodes in a telecommunications network, and, at a selection entity for selecting media-adaptation resources, selecting, from a plurality of media-adaptation resources, a media-adaptation resource for the media stream based on an Internet protocol (IP) topological proximity of the resource to at least one of the nodes.

According to another aspect, the subject matter described herein includes a system for selecting an optimal media-adaptation resource for latency-sensitive applications. The system includes a plurality of media-adaptation resources for processing and adapting media streams, the media-adaptation resources organized into at least one pool, and a selection entity for selecting an optimal media-adaptation resource. The selection entity is configured to select, in response to a determination of a need for a media-adaptation resource for a media stream between nodes in a telecommunication network and from the plurality of media-adaptation resources, a media-adaptation resource for the media stream based on an Internet protocol (IP) topological proximity of the resource to at least one of the nodes.

The subject matter described herein for selecting an optimal media-adaptation resource for latency-sensitive applications may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIGS. 1A and 1B are block diagrams illustrating an exemplary system for selecting an optimal media-adaptation resource for latency-sensitive applications according to an embodiment of the subject matter described herein;

FIG. 2 is a flow chart illustrating an exemplary process for selecting an optimal media-adaptation resource for latency-sensitive applications according to an embodiment of the subject matter described herein; and

FIG. 3 is a block diagram illustrating an exemplary system for selecting an optimal media-adaptation resource for latency-sensitive applications in an IMS network according to an embodiment of the subject matter described herein.

### DETAILED DESCRIPTION

In accordance with the subject matter disclosed herein, systems, methods, and computer readable media are provided for selecting an optimal media-adaptation resource for latency-sensitive applications. In systems that contain multiple media-adaptation resources, the optimal media-adaptation resource for a latency-sensitive media stream is that resource which, after media path optimization, results in the path with the least incremental latency for backhaul to the resource. Thus, where multiple media paths are possible, each media path going through a different media-adaptation resource, the optimal path and associated media-adaptation resource is that path and media-adaptation resource which incurs the least latency compared to the other possible paths and media-adaptation resources.

There are a number of factors that contribute to latency. One such factor is topological distance to the media-adaptation resource. As used herein, the term “topological distance”, abbreviated as “D”, refers to the number of intermediate nodes between the source of a packet and the packet's destination. If the packet source node is directly connected to the packet's destination node, the topological distance between source and destination is zero (D=0). If the packet must go through one intermediate node, such as a routing node, in order to go from the packet source to the packet destination, the topological distance between source and destination equals one (D=1). Topological proximity is inversely related to topological distance: the more topologically distant two nodes are from each other, the less topologically proximate they are to each other; likewise, the more topologically proximate two nodes are from each other, the less topologically distant they are from each other. Put another way, topological distance increases with increasing D values, and topological proximity increases with decreasing D values.

Generally speaking, the more intermediate nodes that a media stream must traverse to get to a media-adaptation resource, the higher the potential latency value, because each intermediate node incurs some delay while it receives, processes, and routes the media packets in the media stream. Thus, given the choice between a first media-adaptation resource that has a topological distance of three (D=3) and a second media-adaptation resource that has a topological distance of seven (D=7), a media path through the first media-adaptation resource will most likely have less latency than a media path through the second media adaptation resource, simply because the packets must travel through fewer intermediate nodes to get to the first media-adaptation resource than they would to get to the second media-adaptation resource.

In one embodiment, the optimal resource may thus be identified and selected from a pool of available media-adaptation resources on the basis of the IP topological proximity of the resource to one or more of the nodes of the media path. For example, where a media stream is communicated between a first node and a second node, such as a source and destination, a media-adaptation resource may be chosen based on its proximity to the source node, based on its proximity to the destination node, or based on some combination of the two proximities.

In one embodiment, where media-adaptation resources are organized into resource pools in which resources are essentially topologically co-located, the optimal pool may be selected based on the IP topological proximity of the pool to one or more of the nodes of the media path.

Reference will now be made in detail to exemplary embodiments of the present invention, examples of which are illustrated in the accompanying drawings. Wherever possible, the same reference numbers will be used throughout the drawings to refer to the same or like parts.

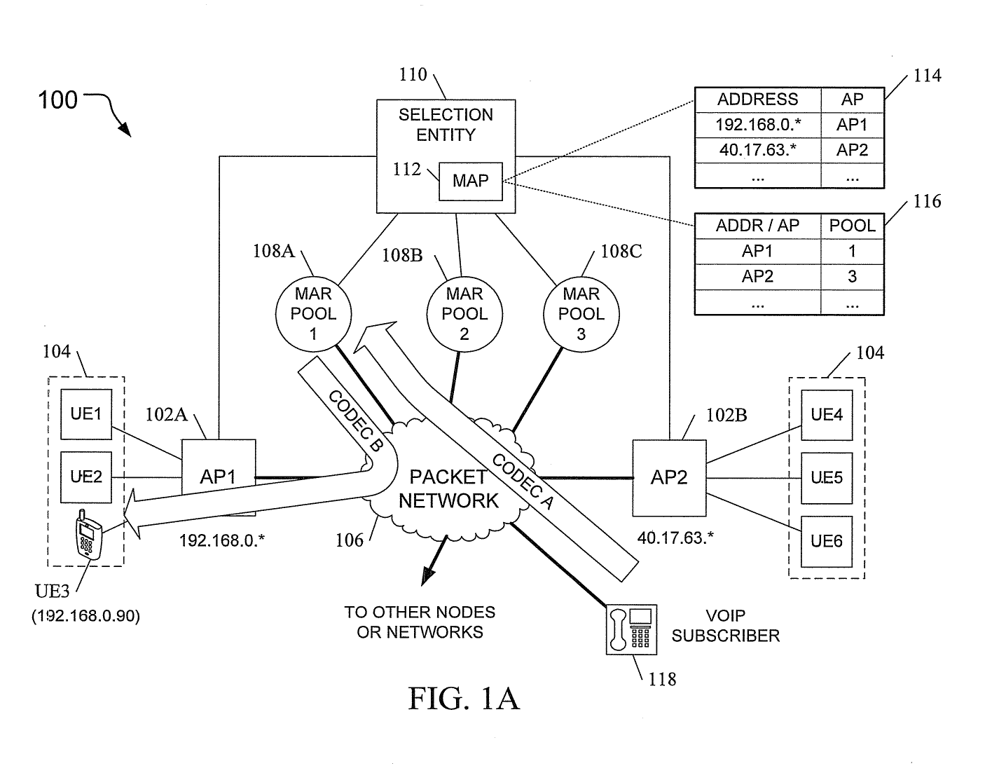

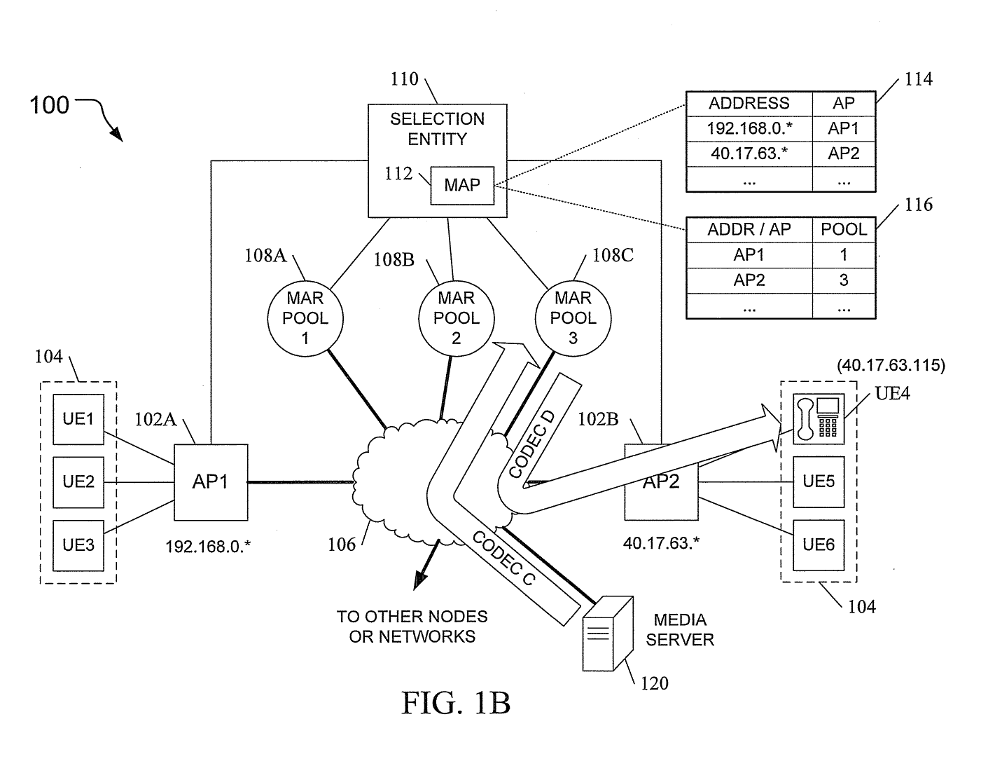

FIG. 1A is a block diagram illustrating an exemplary system for selecting an optimal media-adaptation resource for latency-sensitive applications according to an embodiment of the subject matter described herein. Telecommunications network 100 may include one or more aggregation points for servicing one or more user terminals. In the embodiment illustrated in FIG. 1A, network 100 includes two aggregation points, AP1 102A and AP2 102B, collectively referred to as aggregation points 102. Example aggregation points 102 include, but are not limited to, a gateway general packet radio services (GPRS) support node (GGSN), a public data network (PDN) gateway, a packet data serving node (PDSN), a home agent in a mobile WiMAX or CDMA network, a broadband remote access server (BRAS) in a digital subscriber line (DSL) network, and a cable modem termination system.

User terminals may also be referred to by other names. In second generation (2G) mobile networks, such as GSM networks, a terminal is called a mobile station, or MS. In third generation (3G) mobile networks, such as UMTS networks, a terminal is called user equipment, or UE. For simplicity, the generic term “user terminal” or just “terminal” is hereinafter used to refer to mobile stations in a 2G network and/or user equipment in a 3G network. In the embodiment illustrated in FIG. 1A, aggregation point AP1 102A services three user terminals labeled UE1 through UE3, and aggregation point AP2 102B services three user terminals labeled UE4 through UE6. User terminals UE1 through UE6 are collectively referred to as user terminals 104. Examples of user terminals include, but are not limited to, personal computers, hand-held devices, mobile phones, mobile smart devices, personal digital assistants (PDAs), or other devices that communicate with network 100. In the embodiment illustrated in FIG. 1A, aggregation points 102 connect user terminals 104 to a packet network 106.

Network 100 may include multiple media adaptation resources for performing adaptation functions on media streams. Example media streams include, but are not limited to: voice streams, such as speech; audio streams, such as streaming music; video streams, such as streaming movies or bidirectional videotelephony streams; and any other type of latency-sensitive media that may be transmitted from node to node across a network. Media streams may employ the real time transport protocol (RTP), the hypertext transfer protocol (HTTP) streaming protocol, or other transport protocol for media streams. Example adaptation functions include transcoding, transrating, trans-sizing, and other media adaptations, protocol conversions, etc.

Media adaptation resources may be organized into pools. In the embodiment illustrated in FIG. 1A, network 100 contains three pools of media-adaptation resources, MAR pool 1 108A, MAR pool 2 108B, and MAR pool 3 108C, collectively referred to as media-adaptation resources, resource pools, MAR pools, or simply pools 108. In one embodiment, one or more of the resource pools may be topologically distant from other pools and/or aggregation points 102. For example, MAR pool 1 108A may be within the same subnet as aggregation point AP1 102A while MAR pool 3 108C may be in a different subnet of network 100 or even in a different network altogether. Likewise, MAR pool 3 108C may be topologically proximate to aggregation point AP2 102B but topologically distant from aggregation point AP1 102A. Examples of a media-adaptation resource or a pool of media-adaptation resources include, but are not limited to, a media resource function processor (MRFP), a gateway function, a transition gateway (TrGW), an interconnect border gateway function (I-BGF), a core border gateway function (C-BGF), an access border gateway function (A-BGF), and a media gateway (MGW).

In the embodiment illustrated in FIG. 1A, network 100 includes a selection entity 110 for selecting an optimal media-adaptation resource pool and/or an individual media-adaptation resource on the basis of the IP topological proximity of the resource or pool to a particular user terminal 104 or, since the IP address of terminal 104 is generally associated with the same local area network (LAN) as its aggregation point 102, to the particular aggregation point 102 that is serving the user terminal 104. Examples of a selection entity 110 include, but are not limited to, a media gateway controller (MGC), a media gateway control function (MGCF), a softswitch, a media resource function controller (MRFC), an application server (AS), an interconnect border control function (IBCF), and a policy decision function (PDF). In one embodiment, selection entity 110 may determine the IP address of one of the nodes, such as UE1, by parsing information contained within the request message. For example, if the request message is a SIP INVITE message, selection entity 110 may parse the session description protocol (SDP) portion of the SIP INVITE message to determine the address of the source or destination node of the media stream. The address of the node may be an IP address of the node, such as an IPv4 or IPv6 address. In one embodiment, selection entity 110 may determine the address of the node based on information that may be resolved to an IP address, such as a name. Alternatively, selection entity 110 may determine the IP address aggregation point, such as by looking at address information contained within the packet headers.

In one embodiment, selection entity 110 may access or maintain a map, table, database, etc., that provides a prioritized mapping from sets of network addresses, including, but not limited to, IP addresses or IP address prefixes (for subnets), to media-adaptation resources or media-adaptation resource pools. In the embodiment illustrated in FIG. 1A, selection entity 110 includes a mapping module 112 for this purpose.

In one embodiment, selection entity 110 or mapping module 112 may use one or more tables for mapping a user terminal to a media-adaptation resource pool. In the embodiment illustrated in FIG. 1A, mapping module 112 uses a table 114 for mapping an IP address of a user terminal 104 to the aggregation point 102 that serves that user terminal, and another table 116 for mapping aggregation points 102 to media adaptation resource pools 108. In the embodiment illustrated in FIG. 1A, table 114 includes one or more records, shown as rows, each record mapping an address or range of addresses, shown in the left column, to an aggregation point, shown in the right column, and table 116 includes one or more records, shown as rows, each record mapping an aggregation point 102, shown in the left column, to a media adaptation resource pool 108, shown in the right column.

Aggregation points 102 may dynamically allocate IP addresses to the plurality of user terminals from a provisioned pool of addresses, by using a dynamic host control protocol (DHCP), or by other means. In embodiments where aggregation point 102 dynamically allocates addresses to user terminals 104, the addresses may be allocated from a known or reserved range, and IP routing of the addresses typically results in packet delivery to the LAN of aggregation point 102. Moreover, user terminals may be provisioned with static IP addresses, in which case traffic directed to the user terminal may be delivered to the LAN segment serviced by aggregation point 102. In the embodiment illustrated in FIG. 1A, for example, aggregation point AP1 102A may use DHCP to allocate addresses in the range “192.168.0.*” and aggregation point AP2 102B may use DHCP to allocate addresses in the range “40.17.63.*” where “*” is a value between 1 and 254. This relationship between range of IP addresses and aggregation points is shown in table 114: the first entry in table 114 maps addresses in the range 192.168.0.* to aggregation point AP1 102A, and the second entry in table 114 maps addresses in the range 40.17.63.* to aggregation point AP2 102B.

Mapping module 112 may then use table 116 to map aggregation points to media-adaptation resource pools. In the embodiment illustrated in FIG. 1A, the first entry in table 116 maps aggregation point AP1 102A to media-adaptation resource pool 1 108A and the second entry in table 116 maps aggregation point AP2 102B to media-adaptation resource pool 3 108C.

Using the embodiment illustrated in FIG. 1A, if selection entity 110 or another node within network 100 determines that a media adaptation resource is needed for a media stream originating from a user terminal with address “192.168.0.92”, for example, selection entity 110 may use table 114 to determine that the user terminal is being served by aggregation point AP1 102A and use table 116 to select the media adaptation pool that is most proximate to aggregation point AP1 102A, e.g., pool 108A. Likewise, if selection entity 110 or another node within network 100 determines that a media adaptation resource is needed for a media stream originating from a user terminal with address “40.17.63.12”, for example, selection entity 110 may use table 114 to determine that the user terminal is being served by aggregation point AP2 102B and use table 116 select the media adaptation pool that is most proximate to aggregation point AP2 102B, e.g., pool 108C.

The example embodiment illustrated in FIG. 1A is not intended to be limiting. Other alternative embodiments are within the scope of the subject matter described herein. For example, mapping module 112 may use a single table to map the addresses of individual user terminals or groups of user terminals to the most proximate media adaptation resource pool 108 rather than multiple tables; this may be necessary for user terminals that do not go through an aggregation point. Alternatively, mapping module 112 may also map the addresses of individual user terminals to the most proximate media adaptation resource pool 108; this may be necessary for user terminals that do not go through an aggregation point. Furthermore, selection entity 110 and/or mapping module 112 may use tables, databases, lists, data structures in memory, or other means to store and maintain the mapping information.

In one embodiment, mapping module 112 selects the most proximate media-adaptation resource pool 108 and selection entity 110 then sends to the selected pool a request for an available media-adaptation resource. In such embodiments, the selected media-adaptation resource pool 108 chooses an available media-adaptation resource and notifies selection entity 110 of the choice, e.g., by sending the address or the node identifier of the media adaptation resource to be used. Alternatively, mapping module 112 may maintain more detailed information about the media-adaptation resources available within each pool, select an available media-adaptation resource, and selection entity 110 may interact directly with that resource in resource pool 108. Upon selection of the media-adaptation resource from the chosen media-adaptation resource pool 108, selection entity 110 then inserts the selected media-adaptation resource into the media stream path.

In alternative embodiments, specific media-adaptation resource pool 108 may be selected based on a configured mapping embodied in a data structure or on an algorithmic mapping. In some cases, it may be possible to determine IP topological proximity of the user terminal or aggregation point to the media adaptation resource or resource pool based on the similarity of their respective IP addresses. For example, if a media stream is being transmitted from a source node having an IP address of 64.25.7.117 to a destination node having an IP address of 64.25.7.91, a media-adaptation resource with an address in the same subnet, e.g., 64.25.7.* or 64.25.*.* will likely be topologically closer than a media-adaptation resource with an address not within the same subnet, such as 33.1.14.220.

Alternatively, it may not be possible to determine the IP topological proximity of a media-adaptation resource based on a comparison of source or destination address with the address of the media-adaptation resource. In these cases, a lookup table or database may be created or provisioned for mapping a source or destination address to a media-adaptation resource or to a pool of media-adaptation resources, from which a media-adaptation resource may be selected.

A brief example operation of the system illustrated in FIG. 1A will now be described. In the embodiment illustrated in FIG. 1A, a user of user terminal UE3, which may be, for example, a smart phone, which has been assigned an IP address of 192.168.0.90 by aggregation point AP1 102A, desires to engage in a voice over IP (VoIP) call with VoIP subscriber 118. In this example, selection entity 110 may determine that user terminal UE3 and VoIP subscriber 118 do not support any common speech codec, i.e., that there is no speech codec supported by both user terminal UE3 and VoIP subscriber 118, and that therefore a media-adaptation resource is needed for the media stream. In this scenario, the media stream will be VoIP. Mapping module 112 may then query table 114 using the IP address of user terminal UE3, e.g., 192.168.0.90, to determine that user terminal UE3 is served by aggregation point AP1 102A. Mapping module 112 may then query table 116 using the identity of the aggregation point that is serving user terminal UE3, e.g., “AP1”, to determine that the most proximate pool of media adaptation resources 108 is media adaptation resource pool 1 108A. In an alternate embodiment, a single table may map an IP address or a range of IP addresses to a media-adaptation resource pool.

Once a media-adaptation resource is selected from media adaptation pool 1 108A, selection entity 110 may then insert the selected media-adaptation resource into the media stream path between VoIP subscriber 118 and user terminal UE3. This VoIP call media stream is represented in FIG. 1A as having two segments. The first segment, shown in FIG. 1A as an arrow labeled “CODEC A”, represents a media stream, encoded in one format, that is communicated from VoIP subscriber 118 to the selected media adaptation resource within media adaptation resource pool 1 108A. The selected media-adaptation resource transcodes the media stream from the codec that VoIP subscriber 118 can support into a media stream encoding using a codec that user terminal UE3 can accept, shown in FIG. 1A as an arrow labeled “CODEC B”. This transcoded media stream is communicated from media adaptation resource pool 1 108A to aggregation point AP1 102A, and from there to user terminal UE3. Although the arrows labeled “CODEC A” and “CODEC B” are shown as unidirectional, i.e., from VoIP subscriber 118 to media adaptation resource pool 1 108A, to AP1 102A and to user terminal UE3, the subject matter described herein is not so limited. The media stream represented by these arrows may be bidirectional. Alternatively, these arrows may represent the flow of data from VoIP subscriber 118 to user terminal UE3 while data going in the opposite direction, i.e., from user terminal UE3 to VoIP subscriber 118 may use a partially or completely different path, and may even use a different media adaptation resource pool.

Another brief example operation of the system illustrated in FIG. 1A will now be described with reference to FIG. 1B, in which a numbered element is the same as the like-numbered element of FIG. 1A and the description of which therefore will not be repeated here. In the embodiment illustrated in FIG. 1B, a subscriber using a user terminal, UE4, which may, for example, be a DSL modem on a wireline telephone line, is desiring to download or view a media stream from a media server 120. In this example, user terminal UE4 is being serviced by aggregation point AP2 102B, which has assigned to user terminal UE4 an IP address of 40.17.63.115. Selection entity 110 may determine that user terminal UE4 and media server 120 do not support an codec in common and determine that a media adaptation resource is required to convert a media stream in a first codec supported by media server 120, e.g., “CODEC C”, into a second codec supported by user terminal UE4, e.g., “CODEC D”. Selection entity 110 or mapping function 112 may use table 114 to determine, based on the IP address of user terminal UE4, e.g., “40.17.63.115”, that user terminal UE4 is currently being served by aggregation point AP2 102B. Table 116 can then be queried to determine that the media adaptation resource pool 108 that is most proximate to aggregation point AP2 102B is media adaptation resource pool 3 108C.

Selection entity 110 may then select or request a media adaptation resource from media adaptation resource pool 3 108C to be inserted into the media stream between media server 120 and user terminal UE4. This media stream is represented in FIG. 1B as a first arrow, labeled “CODEC C”, from media server 120 to media adaptation resource pool 3 108C, and a second arrow, labeled “CODEC D”, from media adaptation resource pool 3 108C to user terminal UE4.

It should be noted that although the examples illustrated in FIGS. 1A and 1B show a media adaptation resource pool being selected based on its topological proximity to the destination of the media stream, a media adaptation resource pool may instead be selected based on its topological proximity to the source of the media stream, to the destination of the media stream, to an intermediate node, or some combination of the above.

It will be understood that the systems and methods herein disclosed are applicable to a variety of IP network types and network nodes. Example networks include, but are not limited to, networks that include one or more softswitches or mobile switching center (MSC) servers, such as a next generation network (NGN), an IP multimedia subsystem (IMS) network, H.323 networks, other session initiation protocol (SIP) networks, and networks with MSC servers, such as in legacy mobile station domain (LMSD) networks and 3GPP Release 4 networks.

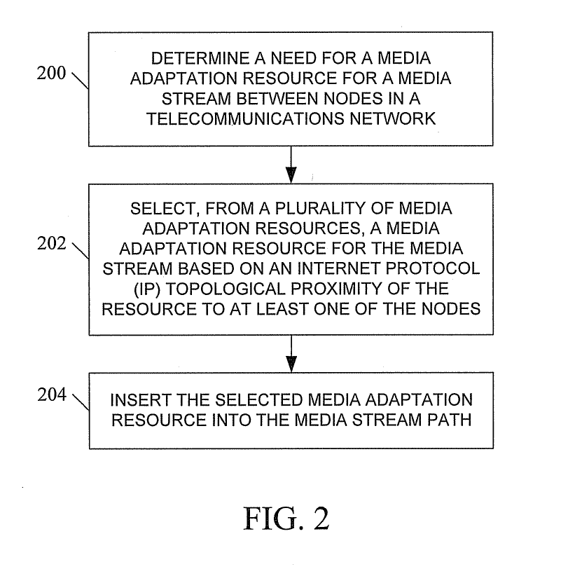

FIG. 2 is a flow chart illustrating an exemplary process for selecting an optimal media-adaptation resource for latency-sensitive applications according to an embodiment of the subject matter described herein. This process will now be described with references to FIGS. 1A and 2.

Referring to FIG. 2, at block 200, it is determined that a media adaptation resource is needed for a media stream between nodes in a telecommunications network. For the purposes of illustration, it will be assumed that the media stream is transmitted between a source node and a destination node. In one embodiment, a node within the signaling path between the source and destination nodes may determine that a media adaptation resource is needed. For example, in IMS networks, signaling messages are received and processed by serving call session control function (S-CSCF) nodes, Application Server (AS) nodes, and Interconnect Border Control Function nodes. These nodes may be configured to determine the need for media-adaptation resources by monitoring the signaling messages that are communicated between the source and destination nodes during the call setup attempt. In an alternative embodiment, a node that is not normally within the signaling path between the source and destination nodes may be provided with information by or from nodes that are within the signaling path between the source and destination nodes, where this information may be analyzed by the node not normally within the signaling path between the source and destination nodes and upon which information the determination may be made. In the embodiment illustrated in FIG. 1A, for example, selection entity 110 may be the node that makes this determination. Alternatively, a node other than selection entity 110 may be the node that makes this determination.

At block 202, a media-adaptation resource for the media stream is selected from multiple media-adaptation resources based on the IP topological proximity of the resource to at least one of the nodes. In one embodiment, the entity that determines the need for a media adaptation resource may be the same node as, a component of, or co-located with an entity that selects the media adaptation resource or resource pool. In the embodiment illustrated in FIG. 1A, for example, selection entity 110 may both determine the need for the adaptation resource and also select the media adaptation resource or resource pool.

Alternatively, the entity that selects the media adaptation resource or resource pool may be distinct from the entity that determines the need for the media adaptation resource. In the embodiment illustrated in FIG. 1A, another node in network 100 may determine the need for a media adaptation resource and, in response to determining that need, send one or more signaling messages to selection entity 110, implicitly or explicitly requesting a media adaptation resource. For simplicity of illustration, it will be hereinafter assumed that selection entity 110 is the node that makes the determination that a media-adaptation resource is needed.

In one embodiment, selection entity 110 may receive a request for a media-adaptation resource to transcode a voice call between a first UE (e.g., UE1), which uses one voice codec, and a second UE (e.g., UE5), which uses another voice codec. UE1 and UE5 may be a pair of cell phones, a cell phone and a fixed-line phone, or even a pair of fixed-line phones. In this example, selection entity 110 may select a media-adaptation resource based on the IP topological proximity of the media-adaptation resource to the source of the media stream, e.g., UE1, to the aggregation point that is serving the source, e.g., AP1 102A, to the destination of the media stream, e.g., UE5, to the aggregation point that is serving the destination, e.g., AP2 102B, or some combination of the above. Selection entity 110 may select a media adaptation resource or resource pool based on the topological proximity of the resource or pool to any other node associated with the media stream.

In one embodiment, selection entity 110 may determine the IP topological proximity of the media-adaptation resource to a node associated with the media stream by determining the IP address of the node associated with the media stream and performing a table or database lookup using the IP address of the node as the key and receiving the identity of the media-adaptation resource as the value. In another embodiment, selection entity 110 may associate the node's IP address with a set of addresses, and use the identified set as the key in a (key, value) lookup. In one embodiment, selection entity 110 may query mapping module 112 to determine the identity of the media-adaptation resource having the closest IP topological proximity to the node. In the embodiment illustrated in FIG. 1A, for example, selection entity 110 may determine that pool 108A is the media-adaptation resource pool having the closest IP topological proximity to UE1.

In one embodiment, selection entity 110 may send a message to the selected pool of media-adaptation resources, requesting or reserving a media-adaptation resource to be allocated from the pool. For example, in one embodiment, selection entity 110 may be an MRFC and pool 108C may be an MRFP. In this example, selection entity 110 may request a resource from the selected MRFP using H.248 signaling, media gateway control protocol (MGCP) signaling, or an equivalent. The MRFP may return (in SDP) addressing information for the media-adaptation resource.

In one embodiment, selection entity 110 may maintain one or more prioritized lists of media-adaptation resource pools. For example, selection entity 110 may maintain a prioritized list for individual IP addresses and/or for sets of IP addresses. In one embodiment, selection entity 110 may attempt to select the highest priority media-adaptation resource pool from the prioritized list, and attempt to select a lower priority media-adaptation resource pool if the higher-priority media-adaptation resource pool has no media-adaptation resources available. For example, if media-adaptation resource pool 1 108A is the closest topologically to UE1 but has no media-adaptation resources available, selection entity 110 may then attempt to reserve a media-adaptation resource from the next closest media-adaptation resource pool, such as media-adaptation resource pool 2 108B, and so on, until an available media-adaptation resource is found.

In one embodiment, selection entity 110 may use factors in addition to IP topological proximity when selecting a media-adaptation resource pool from the prioritized list, such as resource pool adaptation capabilities, current pool utilization, and the like. For example, selection entity 110 may choose not to select a media-adaptation resource from a media-adaptation resource pool that is heavily loaded, even though a media-adaptation resource is available from that pool, if a media-adaptation resource is available from another media-adaptation resource pool that is less heavily loaded.

At block 204, the selected media-adaptation resource is inserted into the media stream path. For example, in the embodiment illustrated in FIG. 1A, the media stream path goes from media server 118 through media-adaptation resource pool 1 108A to aggregation point AP1 102A to user terminal UE3. In the embodiment illustrated in FIG. 1B, the media stream path goes from media server 118 to media-adaptation resource pool 3 108C to aggregation point AP2 102B to user terminal UE4.

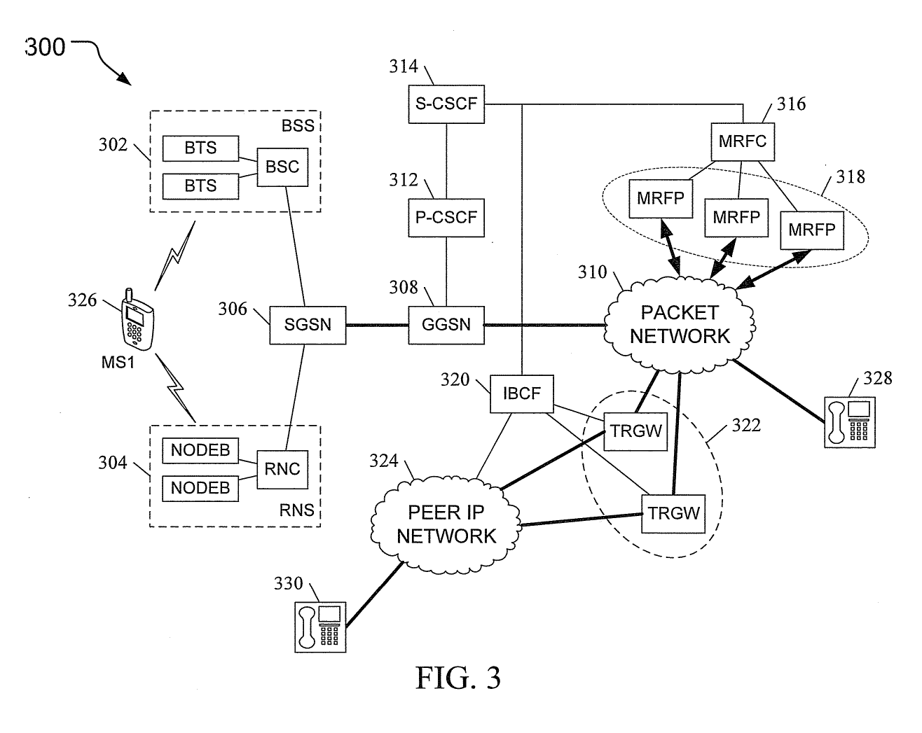

FIG. 3 is a block diagram illustrating an exemplary system for selecting an optimal media-adaptation resource for latency-sensitive applications in an IMS network according to an embodiment of the subject matter described herein. In the embodiment illustrated in FIG. 3, network 300 may include a 2G mobile network base station subsystem (BSS) 302 having a base station controller (BSC) which serves two base transceiver stations (BTS). Network 300 may also include a 3G mobile network radio network subsystem (RNS) 304 having a radio network controller (RNC) which serves two base stations, which are called node Bs (NodeB). BSS 302 and RNS 304 interconnect to a serving general packet radio service (GPRS) support node (SGSN) 306. SGSN 306 may be connected to a gateway GPRS support node (GGSN) 308, which provides interworking between the GPRS network and packet network 310. GGSN 308 may communicate with IMS signaling plane entities, such as proxy call session control function (P-CSCF) 312 and serving call session control function (S-CSCF) 314. S-CSCF 314 may communicate signaling messages with an MRFC 316. MRFC 316 may control multiple MRFPs 318. S-CSCF 314 may also communicate signaling messages with an IBCF 320. IBCF 320 controls multiple TrGWs 322.

In one embodiment illustrated in FIG. 3, GGSN 308 is an aggregation point and MRFC 316 is a selection entity for remote MRFPs 318 serving as pools of media adaptation resources. An IBCF 320 may also function as a selection entity for TrGWs 322 serving as pools of media adaptation resources for bearer traffic between administrative domains, such as between packet network 310 and a peer packet network, such as peer IP network 324. Both MRFPs 318 and TrGWs 322 are entities on the bearer plane, i.e., entities that may be in or inserted into the path of a media stream. In another embodiment illustrated in FIG. 3, in which the MRFC 316 is remote from the S-CSCF 314 and collocated (and possibly integrated) with MRFPs 318, S-CSCF 314 may serve as the selection entity and MRFC 316 as a media adaptation resource pool.

In the embodiment illustrated in FIG. 3, mobile station MS1 326 may generate a SIP INVITE that is directed to a called party 328. The SIP INVITE is tunneled to aggregation point GGSN 308, which forwards the SIP INVITE through P-CSCF 312 to S-CSCF 314. In the course of establishing a call, S-CSCF 314 determines that a media-adaptation resource may be or is required for the call, and sends or forwards a SIP INVITE to MRFC 316. MRFC 316 receives the SIP INVITE and extracts the IP address of MS1 326 from the SDP portion of the request. MRFC 316 determines, based on the IP address of MS1 326, that MS1 326 is associated with aggregation point GGSN 308. MRFC 316 further determines which media-adaptation resource pool MRFP is most proximate to GGSN 308. In another example, in order to establish a call with user equipment 330 in peer IP network 324, S-CSCF 314 may communicate with IBCF 320, which selects an appropriate transition gateway, such as TrGW 322, or an appropriate media-adaptation resource within TrGW 322, based on IP topological proximity of TrGW 322 to the source of the media stream, the destination of the media stream, an intermediate node through which the media stream passes, or some combination of the above. In the SIP context, selection entity 110 may be a back-to-back user agent.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for selecting an optimal media-adaptation resource for latency-sensitive applications, the method comprising:
determining a need for a media-adaptation resource for a media stream between nodes in a telecommunications network; and
at a selection entity for selecting media-adaptation resources, selecting, from a plurality of media-adaptation resources, a media-adaptation resource for the media stream based on an Internet protocol (IP) topological proximity of the resource to at least one of the nodes.

2. The method of claim 1 comprising inserting the selected media-adaptation resource into the media stream path.

3. The method of claim 1 wherein the need for a media-adaptation resource is determined by the selection entity for selecting media-adaptation resources.

4. The method of claim 1 wherein the need for a media-adaptation resource is determined by an entity other than the selection entity for selecting media-adaptation resources.

5. The method of claim 1 wherein determining the need for a media-adaptation resource includes receiving, at the selection entity for selecting media-adaptation resources, a request for a media-adaptation resource for a media stream.

6. The method of claim 5 wherein the received request includes a session description protocol (SDP) portion for negotiating the media stream and wherein determining an IP address of the at least one node comprises using an IP address of the at least one node contained within the SDP portion of the received request.

7. The method of claim 1 wherein selecting a media-adaptation resource for the media stream based on an Internet protocol (IP) topological proximity of the resource to one of the nodes comprises determining an IP address of the at least one node and performing one of:
using the IP address of the at least one node and a mapping function for mapping sets of IP addresses or of IP address prefixes to media-adaptation resources to select a media-adaptation resource; and
using the IP address of the at least one node and a mapping function for mapping sets of IP addresses or of IP address prefixes to pools of media-adaptation resources to select a pool of media-adaptation resources and selecting a media-adaptation resource from the selected pool of media-adaptation resources.

8. The method of claim 1 wherein selecting a media-adaptation resource for the media stream from a plurality of media-adaptation resources includes one of:
selecting, by the selection entity, a pool of media-adaptation resources and selecting, by the selection entity, a media-adaptation resource from the selected pool; and
selecting, by the selection entity, a pool of media-adaptation resources and selecting, by the selected pool, a media-adaptation resource.

9. The method of claim 1 wherein at least one of the nodes is a user terminal.

10. The method of claim 1 wherein at least one of the nodes is an aggregation point that serves a plurality of user terminals.

11. The method of claim 10 wherein the aggregation point comprises one of:
a gateway general packet radio services support node (GGSN);
a packet data network (PDN) gateway;
a packet data serving node (PDSN);
a home agent in a mobile network;
a broadband remote access server (BRAS) in a digital subscriber line (DSL) network; and
a cable modem termination system (CMTS).

12. The method of claim 10 wherein the aggregation point allocates IP addresses to the plurality of user terminals from a pool of addresses by using at least one of a dynamic host control protocol (DHCP) and an allocation of addresses to the user terminals from a configured pool of addresses.

13. The method of claim 12 wherein the aggregation point uses tunneling to route traffic to at least one of the plurality of user terminals.

14. The method of claim 1 wherein the telecommunications network comprises at least one of:
an IP network;
a next generation network (NGN);
an IP multimedia subsystem (IMS) network; and
a session initiation protocol (SIP) network.

15. The method of claim 1 wherein the selection entity comprises one of:
a media gateway controller (MGC);
a media gateway control function (MGCF);
a serving call session control function (S-CSCF);
a media resource function controller (MRFC);
a policy decision function (PDF);
a softswitch;
a mobile switching center (MSC) server;
an application server (AS); and
an interconnect border control function (IBCF).

16. The method of claim 1 wherein the media-adaptation resource comprises one of:
a media gateway (MGW);
a media resource function processor (MRFP);
a gateway function;
a media server;
a transition gateway (TrGW);
an interconnect border gateway function (I-BGF);
a core border gateway function (C-BGF); and
an access border gateway function (A-BGF).

17. The method of claim 1 wherein the media stream comprises one of a real time transport protocol (RTP) session and a hypertext transfer protocol (HTTP) streaming session.

18. The method of claim 1 wherein selecting a media-adaptation resource for the media stream based on an Internet protocol (IP) topological proximity of the resource to one of the nodes includes selecting the first available media-adaptation resource or resource pool respectively from a prioritized list of media-adaptation resources or resource pools.

19. The method of claim 1 wherein using a mapping function for mapping sets of IP addresses or IP address prefixes to media-adaptation resources includes using a mapping function that uses at least one of an algorithm and a fixed mapping.

20. A system for selecting an optimal media-adaptation resource for latency-sensitive applications, the system comprising:
a plurality of media-adaptation resources for processing and adapting media streams, the media-adaptation resources organized into at least one pool; and
a selection entity for selecting an optimal media-adaptation resource, the selection entity being configured to select, in response to a determination of a need for a media-adaptation resource for a media stream between nodes in a telecommunication network and from the plurality of media-adaptation resources, a media-adaptation resource for the media stream based on an Internet protocol (IP) topological proximity of the resource to at least one of the nodes.

21. The system of claim 20 wherein the selection entity is configured to insert the selected media-adaptation resource into the media stream path.

22. The system of claim 20 wherein the need for a media-adaptation resource for a media stream is determined by the selection entity.

23. The system of claim 20 wherein the need for a media-adaptation resource for a media stream is determined by an entity other than the selection entity.

24. The system of claim 20 wherein the need for a media-adaptation resource for a media stream is determined by receiving, at the selection entity, a request for a media-adaptation resource for a media stream from an entity other than the selection entity for selecting media-adaptation resources.

25. The system of claim 24 wherein the received request includes a session description protocol (SDP) portion for negotiating the media stream and wherein determining an IP address of the at least one node comprises using an IP address of the at least one node contained within the SDP portion of the received request.

26. The system of claim 20 wherein the selection entity is configured to select a media-adaptation resource for the media stream based on an Internet protocol (IP) topological proximity of the resource to one of the nodes by determining an IP address of the at least one node and by performing one of:
using the IP address of the at least one node and a mapping function for mapping sets of IP addresses or of IP address prefixes to media-adaptation resources to select a media-adaptation resource; and
using the IP address of the at least one node and a mapping function for mapping sets of IP address or of IP address prefixes to pools of media-adaptation resources to select a pool of media-adaptation resources and selecting a media-adaptation resource from the selected pool of media-adaptation resources.

27. The system of claim 20 wherein the selection entity is configured to select a media-adaptation resource for the media stream based on an Internet protocol (IP) topological proximity of the resource to one of the nodes by at least one of:
selecting, by the selection entity, a pool of media-adaptation resources and selecting, by the selection entity, a media-adaptation resource from the selected pool; and
selecting, by the selection entity, a pool of media-adaptation resources and selecting, by the selected pool, a media-adaptation resource.

28. The system of claim 20 wherein at least one of the nodes is a user terminal.

29. The system of claim 20 wherein at least one of the nodes is an aggregation point that serves a plurality of user terminals.

30. The system of claim 29 wherein the aggregation point comprises one of:
a gateway general packet radio services support node (GGSN);
a packet data network (PDN) gateway;
a packet data serving node (PDSN);
a home agent in a mobile network;
a broadband remote access server (BRAS) in a digital subscriber line (DSL) network; and
a cable modem termination system (CMTS).

31. The system of claim 29 wherein the aggregation point allocates IP addresses to the plurality of user terminals from a pool of addresses by using at least one of a dynamic host control protocol (DHCP) and an allocation of an addresses to user terminals from a configured pool of addresses.

32. The method of claim 31 wherein the aggregation point uses tunneling to route traffic to at least one of the plurality of user terminals.

33. The system of claim 20 wherein the telecommunications network comprises at least one of:
an IP network;
a next generation network (NGN);
an IP multimedia subsystem (IMS) network; and
a session initiation protocol (SIP) network.

34. The system of claim 20 wherein the selection entity comprises one of:
a media gateway controller (MGC);
a media gateway control function (MGCF);
a serving call session control function (S-CSCF);
a media resource function controller (MRFC);
a policy decision function (PDF);
a softswitch;
a mobile switching center (MSC) server;
an application server (AS); and
an interconnect border control function (IBCF).

35. The system of claim 20 wherein the media-adaptation resource comprises one of:
a media gateway (MGW);
a media resource function processor (MRFP);
a gateway function;
a media server;
a transition gateway (TrGW);
an interconnect border gateway function (I-BGF);
a core border gateway function (C-BGF); and
an access border gateway function (A-BGF).

36. The system of claim 20 wherein the media stream comprises one of a real time transport protocol (RTP) session and a hypertext transfer protocol (HTTP) streaming session.

37. The system of claim 20 wherein selecting a media-adaptation resource for the media stream based on an Internet protocol (IP) topological proximity of the resource to one of the nodes includes selecting the first available media-adaptation resource or resource pool respectively from a prioritized list of media-adaptation resources or resource pools.

38. The system of claim 20 wherein using a mapping function for mapping sets of IP addresses or IP address prefixes to media-adaptation resources includes using a mapping function that uses at least one of an algorithm and a fixed mapping.

39. A computer readable medium having stored thereon executable instructions that when executed by the processor of a computer control the computer to perform steps comprising:
determining a need for a media-adaptation resource for a media stream between nodes in a telecommunications network; and
at a selection entity for selecting media-adaptation resources, selecting, from a plurality of media-adaptation resources, a media-adaptation resource for the media stream based on an Internet protocol (IP) topological proximity of the resource to at least one of the nodes.
